(19) United States
(12) Patent Application Publication
(10) Pub. No.: US 2024/0128638 A1
(43) Pub. Date: Apr. 18, 2024

(54) TWIN-BEAM ANTENNAS HAVING HYBRID COUPLERS

(71) Applicant: CommScope Technologies LLC, Hickory, NC (US)

(72) Inventors: Uparnabh Ghoshal, Uttarpara (IN); Upender Reddy Kumbam, Warangal (IN); Kumara Swamy Kasani, GodavariKahani (IN); Ligang Wu, Suzhou (CN)

(21) Appl. No.: 18/485,479

(22) Filed: Oct. 12, 2023

(30) Foreign Application Priority Data
Oct. 13, 2022 (CN) 202211252854.X

(51) Int. Cl. H01Q 1/24; H01Q 3/36

(52) U.S. Cl. CPC H01Q 1/246; H01Q 3/36

(57) ABSTRACT

Twin-beam base station antennas are provided. A twin-beam base station antenna includes a plurality of radiating elements. The twin-beam base station antenna includes a power divider. Moreover, the twin-beam base station antenna includes a hybrid coupler that is coupled between the power divider and some, but not all, of the radiating elements. Related methods of operating twin-beam base station antennas are also provided.

### RELATED APPLICATION

The present application claims priority from and the benefit of Chinese Patent Application No. 202211252854.X, filed Oct. 13, 2022, the disclosure of which is hereby incorporated herein by reference in full.

### FIELD OF THE INVENTION

The present disclosure generally relates to radio communications and, more particularly, to twin-beam base station antennas used in cellular and other communications systems.

### BACKGROUND OF THE INVENTION

Cellular communications systems are well known in the art. In a typical cellular communications system, a geographic area is divided into a series of regions that are referred to as “cells.” and each cell is served by a base station. The base station may include baseband equipment, radios, and base station antennas that are configured to provide two-way radio frequency (“RF”) communications with subscribers that are positioned throughout the cell. In many cases, the cell may be divided into a plurality of “sectors” in the horizontal or “azimuth” plane, and separate base station antennas provide coverage to each of the sectors. The base station antennas are often mounted on a tower or other raised structure, with the radiation beam (“antenna beam”) that is generated by each antenna directed outwardly to serve a respective sector. Typically, a base station antenna includes one or more phase-controlled arrays of radiating elements, with the radiating elements arranged in one or more vertical columns when the antenna is mounted for use. Herein, “vertical” refers to a direction that is perpendicular relative to the plane defined by the horizon.

A common base station configuration is a “three sector” configuration in which the cell is divided into three 120° sectors in the azimuth plane, and the base station includes three base station antennas that provide coverage to the three respective sectors. The azimuth plane refers to a horizontal plane that bisects the base station antenna and is parallel to the plane defined by the horizon. In a three sector configuration, the antenna beams generated by each base station antenna typically have a half power beam width (“HPBW”) in the azimuth plane of about 65° so that the antenna beams provide good coverage throughout a 120° sector. Typically, each base station antenna will include a vertically-extending column of radiating elements that together generate an antenna beam. Each radiating element in the column may have a HPBW of approximately 65° so that the antenna beam generated by the column of radiating elements will provide coverage to a 120° sector in the azimuth plane. The base station antenna may include multiple columns of radiating elements that operate in the same or different frequency bands.

Most modern base station antennas also include remotely controlled phase shifter/power divider circuits along the RF transmission paths through the antenna that allow a phase taper to be applied to the sub-components of an RF signal that are supplied to the radiating element in an array. By adjusting the amount of phase taper applied, the resulting antenna beams may be electrically downtilted to a desired degree in the vertical or “elevation” plane. This technique may be used to adjust how far an antenna beam extends outwardly from an antenna, and hence can be used to adjust the coverage area of the base station antenna.

Sector-splitting refers to a technique where the coverage area for a base station is divided into more than three sectors in the azimuth plane, such as six, nine, or even twelve sectors. A six-sector base station will have six 60° sectors in the azimuth plane. Splitting each 120° sector into two sub-sectors increases system capacity because each antenna beam provides coverage to a smaller area, and therefore can provide higher antenna gain and/or allow for frequency reuse within a 120° sector. In six-sector sector-splitting applications, a single twin-beam antenna is typically used for each 120° sector. The twin-beam antenna generates two separate antenna beams that each have a reduced size in the azimuth plane and that each point in different directions in the azimuth plane, thereby splitting the sector into two smaller sub-sectors. The antenna beams generated by a twin-beam antenna used in a six-sector configuration preferably have azimuth HPBW values of, for example, between about 27°-39°, and the pointing directions for the first and second sector-splitting antenna beams in the azimuth plane are typically at about −27° and about 27°, respectively, from a 0° “azimuth boresight pointing direction” of the antenna, which refers to a horizontal axis that extends from the base station antenna that points to the center, in the azimuth plane, of the sector served by the base station antenna.

Several approaches have been used to implement twin-beam antennas that provide coverage to respective first and second sub-sectors of a 120° sector in the azimuth plane. In a first approach, first and second columns of radiating elements are mounted on the two major interior faces of a V-shaped reflector. The angle defined by the interior surface of the “V” shaped reflector may be about 54° so that the two columns of radiating elements are mechanically positioned or “steered” to point at azimuth angles of about −27° and 27°, respectively (i.e., toward the middle of the respective sub-sectors). As the azimuth HPBW of typical radiating elements is usually appropriate for covering a full 120° sector, an RF lens is mounted in front of the two columns of radiating elements that narrows the azimuth HPBW of each antenna beam by a suitable amount for providing coverage to a 60° sub-sector. Unfortunately, however, the use of RF lenses may increase the size, weight, and cost of the base station antenna, and the amount that the RF lens narrows the beamwidth is a function of frequency, making it difficult to obtain suitable coverage when wideband radiating elements are used that operate over a wide frequency range (e.g., radiating elements that operate over the full 1.7-2.7 gigahertz (“GHz”) cellular frequency range).

In a second approach, two or more columns of radiating elements (typically 2-4 columns) are mounted on a flat reflector so that each column points toward the azimuth boresight pointing direction for the antenna. Two RF ports (per polarization) are coupled to all of the columns of radiating elements through a beamforming network such as a Butler matrix. The beamforming network generates two separate antenna beams (per polarization) based on the RF signals input at the two RF ports, and the antenna beams are electrically steered off the boresight pointing direction of the antenna at azimuth angles of about −27° and 27° to provide coverage to the two sub-sectors. With such beamforming network based twin-beam antennas, the pointing angle in the azimuth plane of each antenna beam and the HPBW of each antenna beam may vary as a function of the frequency of the RF signals input at the two RF ports. In particular, the azimuth pointing direction of the antenna beams (i.e., the azimuth angle where peak gain occurs) tends to move toward the azimuth boresight pointing direction of the antenna and the azimuth HPBW tends to be smaller with increasing frequency. This can lead to a large variation as a function of frequency in the power level of the antenna beam at the outside edges of the sub-sectors, which is undesirable.

In a third approach, a multi-column array of radiating elements (typically three columns per array) is mounted on each exterior panel of a V-shaped reflector to provide a sector-splitting twin-beam antenna. The antenna beams generated by each multi-column array may vary less as a function of frequency as compared to both the lensed and beamforming based twin beam antennas discussed above. Unfortunately, such sector-splitting antennas may require a large number of radiating elements, which increases the cost and weight of the antenna. Additionally, the inclusion of six columns of radiating elements may increase the required width for the antenna and the V-shaped reflector may increase the depth of the antenna, both of which may be undesirable.

Generally speaking, cellular operators desire twin-beam antennas that have azimuth HPBW values of anywhere between 30°-38°, so long as the azimuth HPBW values do not vary significantly (e.g., more than 12°) across the operating frequency band. Likewise, the azimuth pointing angles of the antenna beam peaks may vary anywhere between +/−26° to +/−33°, so long as the azimuth pointing angle does not vary significantly (e.g., more than 4°) across the operating frequency band. The peak azimuth sidelobe levels should preferably be at least 15 decibels (“dB”) below the peak gain value.

### SUMMARY OF THE INVENTION

A twin-beam base station antenna, according to some embodiments, may include an antenna array including a plurality of radiating elements. The twin-beam base station antenna may include first and second power dividers. Moreover, the twin-beam base station antenna may include a hybrid coupler that is coupled between the first and second power dividers and a pair of the radiating elements that are in a row of the antenna array.

In some embodiments, the hybrid coupler may not be coupled to any radiating element other than the pair of the radiating elements.

According to some embodiments, the pair of the radiating elements may be consecutive radiating elements in the row.

In some embodiments, no power divider may be coupled between the hybrid coupler and any radiating element of the pair of the radiating elements.

According to some embodiments, the twin-beam base station antenna may include first and second phase-controllable delay lines that bypass the hybrid coupler. The row may include first through fourth radiating elements. The first power divider may be coupled to the first radiating element by the first phase-controllable delay line. The pair of the radiating elements may include the second and third radiating elements. The second power divider may be coupled to the fourth radiating element by the second phase-controllable delay line.

In some embodiments, the first through fourth radiating elements may be consecutive radiating elements in the row, the row may be a first row of the antenna array, and a second row of the antenna array may include consecutive fifth through eighth radiating elements.

According to some embodiments, the second radiating element may be rotated 180 degrees relative to the first, third, and fourth radiating elements.

In some embodiments, the twin-beam base station antenna may include a reflector. The first and fifth radiating elements may be on a first portion of the reflector. The second, third, sixth, and seventh radiating elements may be on a second portion of the reflector. The fourth and eighth radiating elements may be on a third portion of the reflector. Moreover, the first and third portions of the reflector may be bent relative to the second portion of the reflector.

According to some embodiments, the first and third portions of the reflector may be bent more than 27 degrees relative to the second portion of the reflector.

In some embodiments, the hybrid coupler may be a first hybrid coupler, and the twin-beam base station antenna may include: a second hybrid coupler; and third and fourth power dividers that are coupled between the second hybrid coupler and the second row.

According to some embodiments, the third power divider may be coupled between the second hybrid coupler and the fifth and seventh radiating elements, and the fourth power divider may be coupled between the second hybrid coupler and the sixth and eighth radiating elements.

In some embodiments, a total of three of radiating elements in the row are coupled to the hybrid coupler, or the pair of the radiating elements may be a first pair of radiating elements in the row, and the hybrid coupler may also be coupled to a second pair of radiating elements in the row.

A twin-beam base station antenna, according to some embodiments, may include first and second radiating elements, a power divider, and a hybrid coupler that is coupled between the power divider and the second radiating element. Moreover, the twin-beam base station antenna may include a phase-controllable delay line that bypasses the hybrid coupler and is coupled between the power divider and the first radiating element.

In some embodiments, only two radiating elements may be coupled to the hybrid coupler.

According to some embodiments, the twin-beam base station antenna may include a third radiating element. The third radiating element may be coupled to the hybrid coupler. Moreover, the second radiating element may be rotated 180 degrees relative to the first and third radiating elements.

In some embodiments, the power divider may include a first power divider that is configured to split a first RF signal between the hybrid coupler and the phase-controllable delay line. The phase-controllable delay line may include a first phase-controllable delay line. The twin-beam base station antenna may include: a third radiating element that is coupled to the hybrid coupler; a fourth radiating element; a second power divider, and a second phase-controllable delay line that bypasses the hybrid coupler and is coupled between the second power divider and the fourth radiating element. Moreover, the second power divider may be configured to split a second RF signal between the hybrid coupler and the second phase-controllable delay line.

According to some embodiments, the second phase-controllable delay line may be configured to provide a different phase delay from the first phase-controllable delay line.

In some embodiments, the second radiating element may be between the first radiating element and the third radiating element. The third radiating element may be between the second radiating element and the fourth radiating element.

A twin-beam base station antenna, according to some embodiments, may include first through fourth radiating elements; and a reflector having a first portion having the first radiating element thereon, a second portion having the second and third radiating elements thereon, and a third portion having the fourth radiating element thereon. The first portion of the reflector may be bent more than 33 degrees relative to the second portion of the reflector. Moreover, the third portion of the reflector may be bent more than 33 degrees relative to the second portion of the reflector.

In some embodiments, the first portion of the reflector may be bent more than 35 degrees relative to the second portion of the reflector.

According to some embodiments, the third portion of the reflector may be bent more than 35 degrees relative to the second portion of the reflector.

In some embodiments, the twin-beam base station antenna may include: a power divider; a hybrid coupler that is coupled between the power divider and the second and third radiating elements; and a phase-controllable delay line that bypasses the hybrid coupler and is coupled between the power divider and the first radiating element. The first through fourth radiating elements may be in a row of an antenna array.

A method of operating a twin-beam base station antenna, according to some embodiments, may include providing a first antenna beam via first, second, and third radiating elements of the twin-beam base station antenna, and not via a fourth radiating element of the twin-beam base station antenna. The method may include providing a second antenna beam via the second, third, and fourth radiating elements, and not via the first radiating element. A first phase delay at the first radiating element may not be a multiple of 90 degrees. Moreover, a second phase delay at the fourth radiating element may not be a multiple of 90 degrees.

In some embodiments, the second phase delay may not be equal to the first phase delay.

According to some embodiments, providing the first antenna beam may include splitting, by a first power divider of the twin-beam base station antenna, a first RF signal between: a hybrid coupler that is coupled to the second and third radiating elements; and a first phase-controllable delay line that is coupled to the first radiating element and bypasses the hybrid coupler.

In some embodiments, providing the second antenna beam may include splitting, by a second power divider of the twin-beam base station antenna, a second RF signal between: the hybrid coupler that is coupled to the second and third radiating elements; and a second phase-controllable delay line that is coupled to the fourth radiating element and bypasses the hybrid coupler.

According to some embodiments, the first through fourth radiating elements may be in a first row. Fifth through eighth radiating elements of the twin-beam base station antenna may be in a second row. The first antenna beam may be further provided via the fifth through eighth radiating elements. Moreover, the second antenna beam may be further provided via the fifth through eighth radiating elements.

### BRIEF DESCRIPTION OF THE DRAWINGS

FIG. 1A is a front perspective view of a base station antenna, according to embodiments of the present invention.

FIG. 1B is a front perspective view of the base station antenna of FIG. 1A electrically connected to a radio.

FIG. 1C is a schematic block diagram of ports of the base station antenna of FIG. 1A electrically connected to ports of the radio of FIG. 1B.

FIG. 1D is a schematic block diagram of ports of the base station antenna of FIG. 1A electrically connected to ports of two radios.

FIG. 2A is an example schematic front view of the four columns of radiating elements included in the antenna of FIG. 1A.

FIG. 2B is a schematic block diagram of the feed network of FIG. 1C coupled to the five rows of radiating elements included in the antenna of FIG. 1A.

FIG. 2C is a schematic block diagram of a portion of the feed network of FIG. 2B that is coupled to the first row of radiating elements of FIG. 2B.

FIG. 2D is a schematic block diagram of a portion of the feed network of FIG. 2B that is coupled to the second row of radiating elements of FIG. 2B.

FIG. 2E is a schematic top view of a reflector having the radiating elements included in the antenna of FIG. 1A thereon.

FIGS. 3 and 4 are schematic block diagrams of different examples of a portion of the feed network of FIG. 1C, according to other embodiments of the present invention.

FIGS. 5A-5F are flowcharts illustrating operations of providing an antenna beam via the radiating elements shown in FIG. 2A.

### DETAILED DESCRIPTION OF THE INVENTION

Pursuant to embodiments of the present invention, improved twin-beam base station antennas are provided that overcome or mitigate various of the difficulties with conventional columns of base station antenna radiating elements. The twin-beam antennas according to embodiments of the present invention may use most (but not all) radiating elements in a row of radiating elements to generate each antenna beam, thereby producing a wider azimuth HPBW than if every radiating element in the row were used to generate each antenna beam.

For example, the antenna may have four columns of radiating elements, where the leftmost three radiating elements in each row may be used to generate the first antenna beam, and the rightmost three radiating elements in each row may be used to generate the second antenna beam. This may be accomplished by splitting each RF input signal using a respective power divider, feeding an output of the first power divider directly to a first of the radiating elements in the row, feeding an output of the second power divider directly to a second of the radiating elements in the row, and feeding the other outputs of the power dividers to respective inputs of a hybrid coupler. Outputs of the hybrid coupler are coupled to the third and fourth radiating elements in the row. In some embodiments, the first and second radiating elements may be the outer radiating elements in the row, and the third and fourth radiating elements may be the inner radiating elements in the row. Because the power dividers are before the inputs to the hybrid coupler, the phases of the RF signals fed to each radiating element in the row are independently controllable.

In some embodiments, a phase-controllable delay line may be coupled between each power divider and a respective outermost radiating element in the row. These delay lines may help to control azimuth HPBW of the twin beams at the lower end of a frequency band. Moreover, the delay lines may provide flexibility to control the beam peak of each antenna beam independently of the other antenna beam that is provided via the row. According to some embodiments, no power divider may be coupled between the hybrid coupler and any of the radiating elements in the row, and the risk of non-linearity of phase at the radiating elements due to a power divider can thus be reduced. Another row of radiating elements, however, may be fed by two power dividers that are fed by a hybrid coupler, and this may improve azimuth performance (e.g., may narrow azimuth HPBW at the lower end of the frequency band) by increasing aperture sharing.

According to some embodiments, performance of a twin-beam antenna may be improved by using a bent reflector. The bent reflector may have a first (central) section that includes columns of radiating elements that are used to form both the first and second antenna beams, a second (right) section that includes a column of radiating elements that is only used in forming the first antenna beam, and a third (left) section that includes a column of radiating elements that is only used in forming the second antenna beam. By bending the reflector, columns of radiating elements that are only used to form one of the two antenna beams may be “mechanically steered” so that the RF energy emitted by the radiating elements in the column will be emitted at an angle that is closer to the boresight pointing direction of the antenna beam. This may improve the pattern shape of the generated first and second antenna beams. In some embodiments, the bends in the reflector may about match the boresight pointing directions of the first and second antenna beams (i.e., the bends may be about −27 degrees and 27 degrees, respectively). In other embodiments, the bends may actually exceed the boresight pointing directions of the first and second antenna beams. Applicant has discovered that the performance of a twin-beam antenna may be improved by bending a reflector more than 27 degrees between radiating elements.

Radiating elements that are described herein may be, for example, dual-polarized radiating elements. Each dual-polarized radiating element includes a first polarization radiator and a second polarization radiator. The most commonly used dual-polarized radiating elements are crossed-dipole radiating elements that include a slant −45° dipole radiator and a slant +45° dipole radiator. Example dual-polarization dipole radiating elements are discussed in International Patent Application No. PCT/US2020/023106, published as WO 2020/205225, the disclosure of which is hereby incorporated herein by reference in its entirety. It will be appreciated, however, that any appropriate radiating elements may be used, including, for example, single polarization dipole radiating elements or patch radiating elements, in other embodiments.

Example embodiments of the present invention will be described in greater detail with reference to the attached figures.

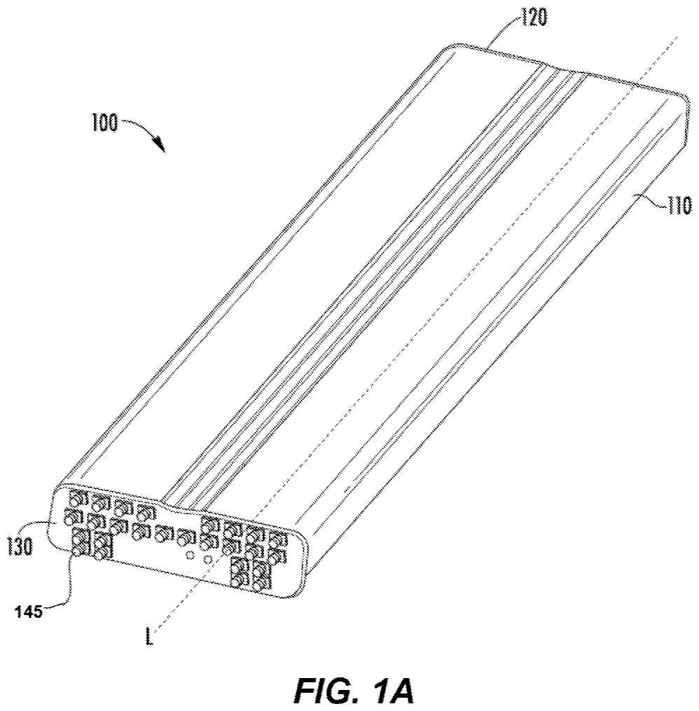

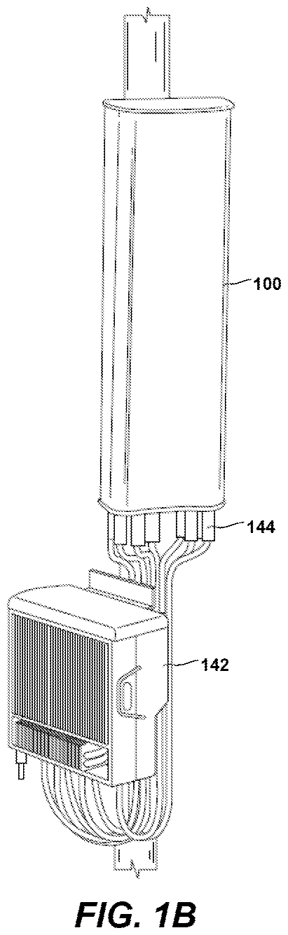

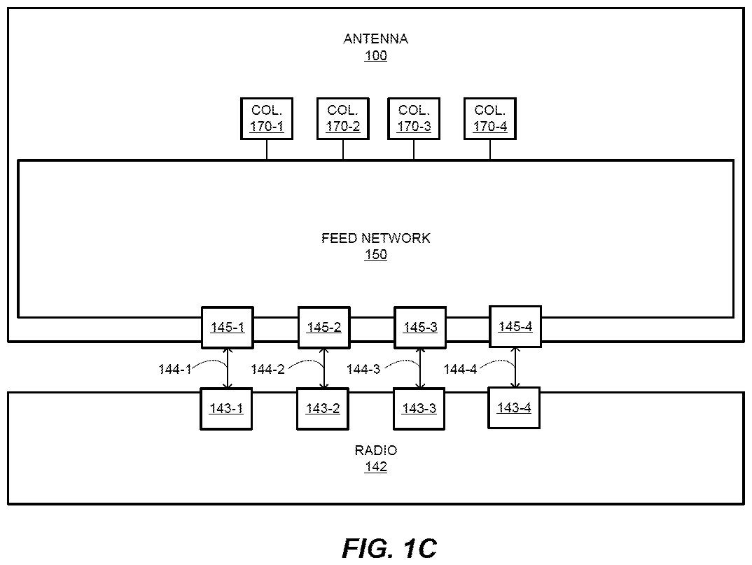

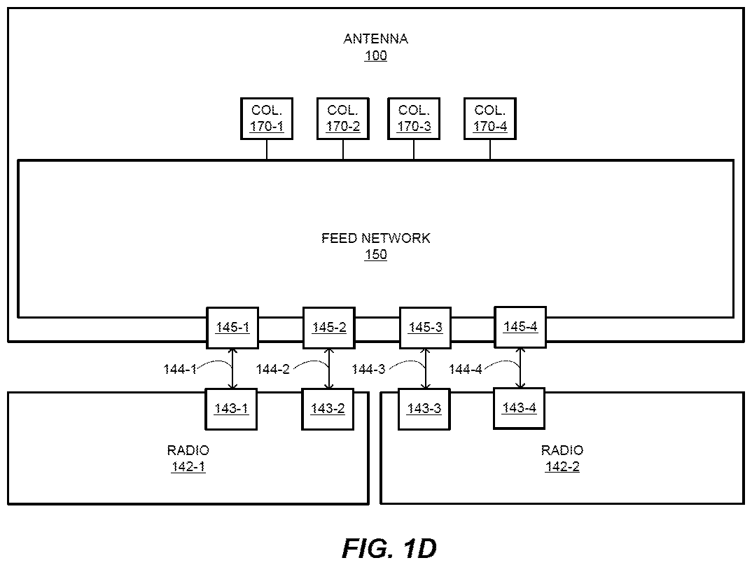

FIG. 1A is a front perspective view of a base station antenna 100 according to embodiments of the present invention. The antenna 100 may be, for example, a cellular base station antenna at a macrocell base station. As shown in FIG. 1A, the antenna 100 is an elongated structure and has a generally rectangular shape. The antenna 100 includes a radome 110. In some embodiments, the antenna 100 further includes a top end cap 120 and/or a bottom end cap 130. The bottom end cap 130 may include a plurality of RF connectors 145 mounted therein. The connectors 145, which may also be referred to herein as RF “ports,” are not limited, however, to being located on the bottom end cap 130. Rather, one or more of the connectors 145 may be provided on, for example, the rear (i.e., back) side of the radome 110 that is opposite the front side of the radome 110. The antenna 100 is typically mounted in a vertical configuration (i.e., the long side of the antenna 100 extends along a vertical axis L with respect to Earth).

FIG. 1B is a front perspective view of the base station antenna 100 electrically connected to a radio 142 by RF transmission lines 144, such as coaxial cables. For example, the radio 142 may be a cellular base station radio, and the antenna 100 and the radio 142 may be located at (e.g., may be components of) a cellular base station. In some cases, the radio 142 may be mounted on the back surface of the antenna 100 rather than below the antenna 100. According to some embodiments, a single radio 142 may be coupled to the antenna 100. In other embodiments, multiple radios 142 may be coupled to the antenna 100.

FIG. 1C is a schematic block diagram of ports 145 of the base station antenna 100 electrically connected to respective ports 143 of the radio 142. As shown in FIG. 1C, ports 145-1 through 145-4 of the antenna 100 are electrically connected to ports 143-1 through 143-4, respectively, of the radio 142 by respective RF transmission lines 144-1 through 144-4, such as coaxial cables. For example, the ports 145-1 and 145-3 may be first-polarization ports, and the ports 145-2 and 145-4 may be second-polarization ports, where the second polarization is different from (e.g., orthogonal to) the first polarization.

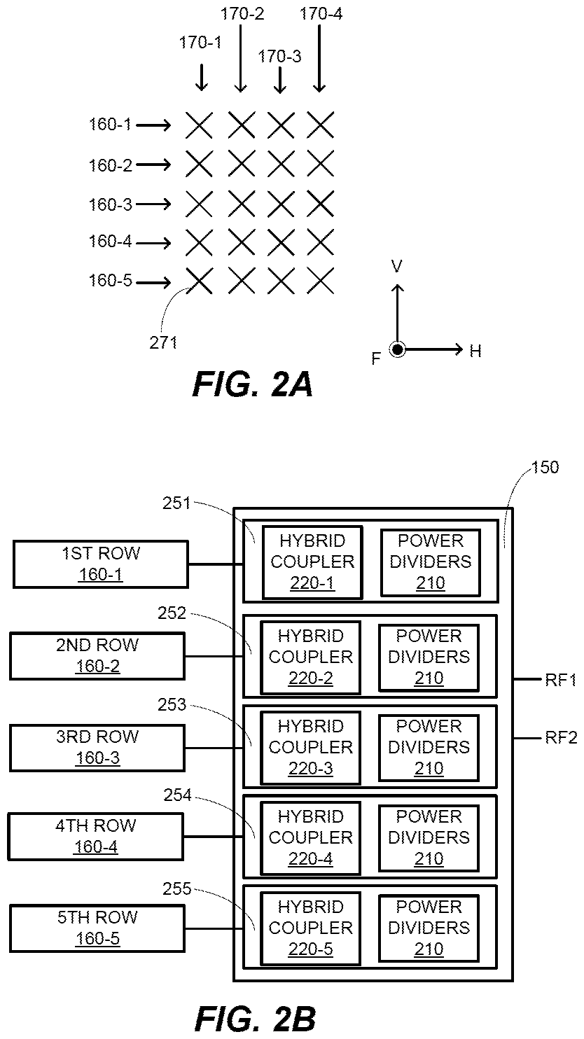

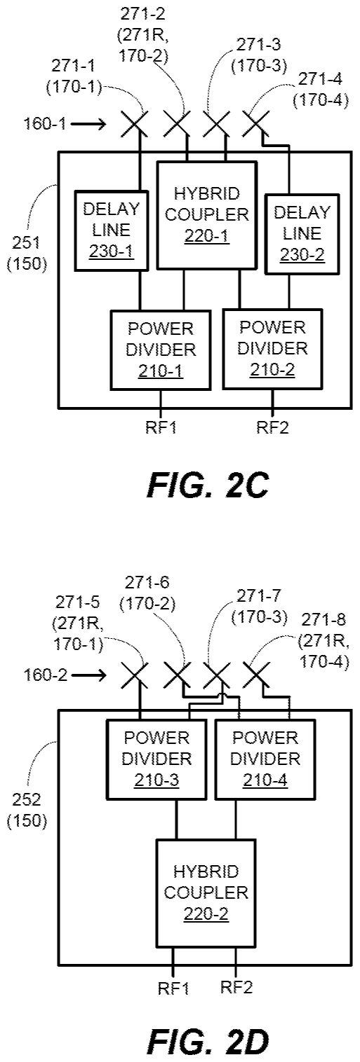

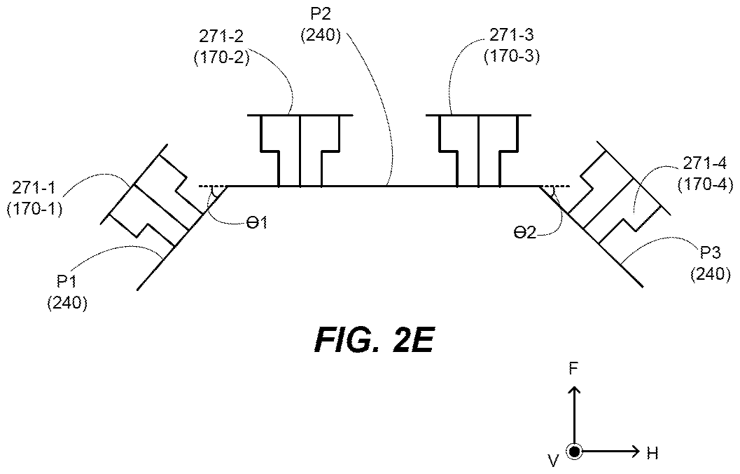

The antenna 100 may include rows 160-1 through 160-5 (FIG. 2A) and vertical columns 170-1 through 170-4 of radiating elements 271 (FIG. 2A) that are configured to transmit and/or receive RF signals. The antenna 100 may also include a feed network 150 that is coupled between the radio 142 and the radiating elements 271. For example, radiating elements 271 that are in the rows 160 may be coupled to RF transmission paths (e.g., including one or more RF transmission lines) of the feed network 150.

In some embodiments, the feed network 150 may include feed circuitry that is coupled between the ports 145 and radiating elements 271 that are in the rows 160. The feed circuitry can couple downlink RF signals from the radio 142 to radiating elements 271. The feed circuitry may also couple uplink RF signals from radiating elements 271 to the radio 142. For example, the feed circuitry may include power dividers, RF switches, RF couplers, and/or RF transmission lines.

For simplicity of illustration, FIG. 1C (and FIG. 1D, discussed below) only illustrates the four columns 170-1 through 170-4 of radiating elements 271. It will be appreciated that the base station antenna 100 may include additional columns of radiating elements and additional RF ports that are not shown in FIG. 1C.

FIG. 1D is a schematic block diagram of ports 145 of the base station antenna 100 of FIG. 1A electrically connected to ports 143 of first and second radios 142-1, 142-2. As shown in FIG. 1D, the first radio 142-1 may have two ports 143-1 and 143-2 that are coupled to two ports 145-1 and 145-2, respectively, of the antenna 100. Moreover, the second radio 142-2 may have two ports 143-3 and 143-4 that are coupled to two ports 145-3 and 145-4, respectively, of the antenna 100.

FIG. 2A is an example schematic front view of the four vertical columns 170-1 through 170-4 of radiating elements 271 included in the base station antenna 100 of FIG. 1A. The four vertical columns 170-1 through 170-4 are spaced apart from each other in a horizontal direction H. Each vertical column 170 of radiating elements 271 may extend in a vertical direction V from a lower portion of the antenna 100 to an upper portion of the antenna 100.

FIG. 2A also shows that the radiating elements 271 are in five rows 160-1 through 160-5. The five rows 160-1 through 160-5 are spaced apart from each other in the vertical direction V. Each row 160 of radiating elements 271 may extend in the horizontal direction H from a left side of the antenna 100 to a right side of the antenna 100.

The vertical direction V may be, or may be parallel with, the longitudinal axis L (FIG. 1A). The vertical direction V may also be perpendicular to the horizontal direction H and a forward direction F. As used herein, the term “vertical” does not necessarily require that something is exactly vertical (e.g., the antenna 100 may have a small mechanical down-tilt).

The columns 170 and rows 160 are each configured to transmit and/or receive RF signals in one or more frequency bands, such as one or more bands comprising frequencies between 1427 megahertz (“MHz”) and 2690 MHz or a portion thereof. Though FIG. 2A illustrates four columns 170-1 through 170-4 and five rows 160-1 through 160-5, the antenna 100 may include more columns 170 and/or more or fewer rows 160. For example, in other embodiments, the antenna 100 may include five or six columns 170. Moreover, the number of radiating elements 271 in a column 170 can be any quantity from two to twenty or more. For example, the four columns 170-1 through 170-4 shown in FIG. 2 may each have five to twenty radiating elements 271. In some embodiments, the columns 170 may each have the same number (e.g., five) of radiating elements 271.

FIG. 2B is a schematic block diagram of the feed network 150 of FIG. 1C coupled to the five rows 160-1 through 160-5 of radiating elements 271 included in the antenna 100 of FIG. 1A. The five rows 160-1 through 160-5 are coupled to five portions 251-255, respectively, of the feed network 150. The five portions 251-255 include five RF hybrid couplers 220-1 through 220-5, respectively, and a plurality of power dividers 210. Each hybrid coupler 220 may be fed by a pair of power dividers 210, or may feed a pair of power dividers 210.

A hybrid coupler is a four-port device. RF signals may be input at first and second ports of the hybrid coupler, and sub-components of each input RF signal are output at the third and fourth ports of the RF coupler. In the most typical design, each input RF signal is split in half so that the signals output at each output port comprise a combination of half of the first input RF signal and half of the second input RF signal. Moreover, the RF signals at the two output ports may have a 90-degree or 180-degree phase difference therebetween. Accordingly, each hybrid coupler 220 may, in some embodiments, be a 90-degree hybrid coupler that outputs two RF signals having a 90-degree phase difference with each other. For example, a hybrid coupler 220 may output the RF signals to respective radiating elements 271 of a row 160.

RF signals that are output by the hybrid couplers 220 may be based on first and second RF signals RF1 and RF2 that are input to the feed network 150. The first RF signal RF1 may be divided into five sub-components (e.g., using one or more power dividers) and each sub-component may be passed to a respective one of the rows 160-1 through 160-5. Similarly, the second RF signal RF2 may be divided into five sub-components (e.g., using one or more power dividers) and each sub-component may be passed to a respective one of the rows 160-1 through 160-5. The five rows 160-1 through 160-5 of radiating elements 271 may thus collectively generate first and second antenna beams based on the first and second RF signals RF1 and RF2, respectively. The first and second RF signals RF1 and RF2 (e.g., five sub-components thereof) may be fed to each of the five portions 251-255 of the feed network 150 by a single radio 142 (FIG. 1C), or by respective radios 142-1 and 142-2 (FIG. 1D). In some embodiments, the first and second RF signals RF1 and RF2 may both be provided to the feed network 150 via first-polarization ports (e.g., ports 145-1 and 145-3 of FIG. 1C or FIG. 1D) of the antenna 100.

For simplicity of illustration. RF signals and hybrid couplers 220 for only one polarization are shown in FIG. 2B. As an example, the five hybrid couplers 220-1 through 220-5 may all be first-polarization hybrid couplers. Accordingly, an additional five hybrid couplers 220 may be coupled to additional power dividers 210 in the feed network 150, where the additional five hybrid couplers 220 are all second-polarization hybrid couplers. Also, two additional RF signals may be provided to the feed network 150 via second-polarization ports (e.g., ports 145-2 and 145-4 of FIG. 1C or FIG. 1D) of the antenna 100. The antenna 100 may thus generate two antenna beams per polarization.

FIG. 2C is a schematic block diagram of the first portion 251 of the feed network 150 of FIG. 2B that is coupled to first through fourth radiating elements 271-1 through 271-4 of the first row 160-1 of FIG. 2B. As shown in FIG. 2C, the first row 160-1 includes exactly four radiating elements 271. Moreover, the first portion 251 of the feed network 150 may include first and second power dividers 210-1 and 210-2 and a first hybrid coupler 220-1 that is coupled between the first and second power dividers 210-1 and 210-2 and a pair of radiating elements 271 of the first row 160-1. As shown in FIG. 2C, in some embodiments, no power divider 210 is coupled between the first hybrid coupler 220-1 and any of the radiating elements 271 in the first row 160-1, and the first hybrid coupler 220-1 may not be coupled to any radiating element 271 other than the pair of the radiating elements 271. Accordingly, only the pair of the radiating elements 271 (i.e., only two radiating elements 271) may be coupled to outputs of the first hybrid coupler 220-1.

The pair of radiating elements 271 may include the second and third radiating elements 271-2 and 272-3, which are consecutive radiating elements 271 that do not have any other radiating element 271 of the first row 160-1 therebetween. As the first through fourth radiating elements 271-1 through 271-4 are consecutive radiating elements 271, the second radiating element 271-2 is between the first and third radiating elements 271-1 and 271-3, and the third radiating element 271-3 is between the second and fourth radiating elements 271-2 and 271-4.

The first and second RF signals RF1 and RF2 (e.g., respective sub-components thereof) are fed to the first and second power dividers 210-1 and 210-2, respectively. The first power divider 210-1 splits the first RF signal RF1 between the first hybrid coupler 220-1 and a first phase-controllable delay line 230-1. The second power divider 210-2 splits the second RF signal RF2 between the first hybrid coupler 220-1 and a second phase-controllable delay line 230-2. The first and second delay lines 230-1 and 230-2 feed the first and fourth radiating elements 271-1 and 271-4, respectively, and bypass (i.e., do not feed) the first hybrid coupler 220-1. Accordingly, the first power divider 210-1 feeds the first through third radiating elements 271-1 through 271-3 (and not the fourth radiating element 271-4), and the second power divider 210-2 feeds the second through fourth radiating elements 271-2 through 271-4 (and not the first radiating element 271-1).

The first and second delay lines 230-1 and 230-2 may, in some embodiments, be configured to provide different amounts of phase delay from each other. For example, the first and second delay lines 230-1 and 230-2 may be configured to provide −270 degrees and −90 degrees, respectively, of phase delay (relative to the first and second RF signals RF1 and RF2, respectively, at inputs to the first hybrid coupler 220-1) under ideal conditions. As conditions are not always ideal, however, a phase delay of an RF signal output from the first delay line 230-1 to the first radiating element 271-1 may not be a multiple of 90 degrees (e.g., may not be −90, −180, or −270 degrees). Similarly, a phase delay of an RF signal output from the second delay line 230-2 to the fourth radiating element 271-4 may not be a multiple of 90 degrees.

In some embodiments, the first and second delay lines 230-1 and 230-2 may be respective phase cables. The amount of delay provided by each phase cable can vary based on the length of the cable. Moreover, phase delays provided by the first and second delay lines 230-1 and 230-2 may be frequency dependent. The first and second delay lines 230-1 and 230-2 can keep azimuth HPBW from becoming too wide at the lower end of an operating frequency band of the radiating elements 271. According to some embodiments, the first and second delay lines 230-1 and 230-2 can provide flexibility to independently control the beam peaks of the two antenna beams that are generated by the first row 160-1.

A first antenna beam is generated using the first through third radiating elements 271-1 through 271-3, and not the fourth radiating element 271-4. A second antenna beam is generated using the second through fourth radiating elements 271-2 through 271-4, and not the first radiating element 271-1. The first and second antenna beams may point, for example, at angles of +27° and −27° in the azimuth plane, respectively. By using only three radiating elements 271 at a time from the first row 160-1 to generate each antenna beam, a wider azimuth HPBW may be provided at higher frequencies of an operating frequency band of the radiating elements 271.

A single radiating element 271 in the first row 160-1 may be rotated, in the H-V plane (FIG. 2A), relative to the other radiating elements 271 in the first row 160-1. For example, FIG. 2C shows that the second radiating element 271-2 may be a rotated radiating element 271R. As an example, dipole radiators of the rotated radiating element 271R may be rotated 180 degrees, in the H-V plane, relative to dipole radiators of the first, third, and fourth radiating elements 271-1, 271-3, and 271-4. The rotated radiating element 271R may thus be a middle radiating element 271 for generating the first antenna beam, and an outermost radiating element 271 for generating the second antenna beam.

In some embodiments, the second through fifth portions 252-255 (FIG. 2B) of the feed network 150 may be analogous to the first portion 251. Accordingly, each hybrid coupler 220 may be fed by two power dividers 210, as shown in FIG. 2C. In other embodiments, one or more of the second through fifth portions 252-255 may include a hybrid coupler 220 that feeds two power dividers 210. For example, the second and fourth portions 252 and 254 may each include a hybrid coupler 220 that feeds two power dividers 210, and the third and fifth portions 253 and 255 may each include a hybrid coupler 220 that is fed by two power dividers 210. By including a combination of (a) rows 160 having hybrid couplers 220 that are fed by two power dividers 210 and (b) rows 160 having hybrid couplers 220 that feed two power dividers 210, azimuth HPBW at the lower end of an operating frequency band of the radiating elements 271 may be narrowed.

FIG. 2D is a schematic block diagram of a second portion 252 of the feed network 150 of FIG. 2B that is coupled to the second row 160-2 of FIG. 2B. As shown in FIG. 2D, the second row 160-2 may include exactly four radiating elements 271, which comprise consecutive fifth through eighth radiating elements 271-5 through 271-8. The second portion 252 includes a second hybrid coupler 220-2 that feeds third and fourth power dividers 210-3 and 210-4, which feed the second row 160-2. According to some embodiments, the first and second hybrid couplers 220-1 and 220-2 may be part of the same beamforming network.

The third power divider 210-3 of the second portion 252 of the feed network 150 is coupled between the second hybrid coupler 220-2 and the fifth and seventh radiating elements 271-5 and 271-7. The fourth power divider 210-4 of the second portion 252 is coupled between the second hybrid coupler 220-2 and the sixth and eighth radiating elements 271-6 and 271-8. Accordingly, unlike the first portion 251 of the feed network 150 that is shown in FIG. 2C, the second portion 252 simultaneously feeds all four radiating elements 271 of the second row 160-2 to generate each of the first and second antenna beams.

Because the fifth through eighth radiating elements 271-5 through 271-8 are all used to generate each of the first and second antenna beams, the azimuth HPBW may be very narrow at higher frequencies of an operating band of the radiating elements 271. By providing the second row 160-2 in combination with the first row 160-1, which only uses three radiating elements 271 to generate each antenna beam, however, the azimuth HPBW of the first and second antenna beams may be better balanced (i.e., not too narrow and not too wide). In some embodiments, the fourth portion 254 (FIG. 2B) of the feed network 150 may include connections analogous to those shown in FIG. 2D with respect to the second portion 252, and the third and fifth portions 253 and 255 (FIG. 2B) of the feed network 150 may include connections analogous to those shown in FIG. 2C with respect to the first portion 251. Moreover, the shape of the first and second antenna beams may be changed by using more rows 160 that are fed analogously to the first row 160-1 or more rows 160 that are fed analogously to the second row 160-2.

The different ways that the first and second rows 160-1 and 160-2 are fed can also influence phases of RF signals at the first and second rows 160-1 and 160-2. As an example, phases are not independently controllable for the four radiating elements 271-5 through 271-8 of the second row 160-2, as they are all dependent on phases generated by the second hybrid coupler 220-2. Also, any alteration in phase at an input of the second hybrid coupler 220-2 can significantly impact azimuth beam peaks of the first and second antenna beams. By using the differently-fed first and second rows 160-1 and 160-2 together, however, azimuth beam peak walking can be reduced (e.g., to about five degrees) and the delay lines 230 (FIG. 2C) that are coupled to the first row 160-1 can provide flexibility to independently control the beam peaks of the two antenna beams that are generated by the rows 160. Moreover, amplitude taper control of sidelobes may increase due to power dividers 210 that are at inputs, rather than outputs, of the first hybrid coupler 220-1 that is coupled to the first row 160-1.

FIG. 2D also shows that two radiating elements 271 of the second row 160-2 may be rotated relative to the other two radiating elements of the second row 160-2. For example, FIG. 2D illustrates that the fifth and eighth radiating elements 271-5 and 271-8 are rotated radiating elements 271R, which may be rotated 180 degrees, in the H-V plane (FIG. 2A), relative to the sixth and seventh radiating elements 271-6 and 271-7.

In some embodiments, all of the columns of radiating elements in the antenna array may be mounted on a planar reflector to provide a planar array of radiating elements. In such embodiments, the beamforming network is configured to electronically scan the first and second antenna beams in opposite directions in the azimuth plane so that those antenna beams point in the appropriate directions to provide coverage to the two 60-degree sub-sectors. In other embodiments, the twin-beam antennas may include a bent reflector.

FIG. 2E is a schematic top view of a reflector 240 having radiating elements 271 included in the antenna 100 of FIG. 1A thereon. The reflector 240 is inside the radome 110 (FIG. 1A), which is omitted from view in FIG. 2E for simplicity of illustration. Though the five rows 160-1 through 160-5 (FIG. 2A) of radiating elements 271 may all be mounted on the reflector 240, only the first row 160-1 is visible in the top view of FIG. 2E.

As shown in FIG. 2E, the first column of radiating elements (which includes radiating element 271-1) is on a first portion P1 of the reflector 240, the second and third columns of radiating elements (which include radiating elements 271-2 and 271-3) are on a second portion P2 of the reflector 240, and the fourth column of radiating elements (which includes radiating element 271-4) is on a third portion P3 of the reflector 240. The second portion P2 is parallel with the horizontal direction H, and the first and third portions P1 and P3 are bent at first and second angles θ1 and θ2, respectively, relative to the second portion P2.

The columns of radiating elements mounted on the second (central) portion P2 are columns of radiating elements that are used to form both the first and second antenna beams, the column of radiating elements mounted on the first portion P1 is the column that is only used in forming the first antenna beam, and the column of radiating elements mounted on the third portion P3 is the column of radiating elements that is only used in forming the second antenna beam. By bending the reflector, columns of radiating elements that are only used to form one of the two antenna beams may be “mechanically steered” so that the RF energy emitted by the radiating elements in the column will be emitted at an angle that is closer to the boresight pointing direction of the antenna beam. Generally, when antenna beams are electronically steered, the shape of the radiation pattern undergoes some amount of undesired distortion. Because some columns of radiating elements in embodiments of the present invention may only be used in generating one of the two antenna beams, those columns of radiating elements may be mechanically steered by bending the reflector so that the radiation emitted by the column points in a desired direction (or at least closer to a desired direction than would be the case if all of the columns of radiating elements were mounted on a single flat section of the reflector). Thus, the shape of the antenna beams may be improved by bending the reflector so that one or more columns of radiating elements are mounted on panels that are arranged at an angle with respect to panels on which other columns of radiating elements are mounted.

In some embodiments, the first portion P1 may be bent at an angle of about −25 to −30 degrees with respect to the second portion P2 and the third portion P3 may be bent at an angle of about 25 to 30 degrees with respect to the second portion P2. In such embodiments, the first column is mechanically steered to point at about the desired the boresight pointing direction of the first antenna beam in the azimuth plane and the fourth column is mechanically steered to point at about the desired the boresight pointing direction of the second antenna beam in the azimuth plane. In other embodiments, the bends in the reflector may be less. In such embodiments, the first and fourth columns may need some amount of electronic steering so that the RF energy emitted thereby is emitted in the desired directions, and hence the shape of the antenna beams may not be as good as if larger bends are used. Shorter bends in the reflector, however, may facilitate reducing the overall depth of the base station antenna. Thus, there may be a tradeoff between the size of the base station antenna and the desirability of the shapes of the antenna beams.

In still other embodiments, the bends in the reflector may actually be greater than the pointing directions of the first and second antenna beams in the azimuth plane. For example, in a twin beam antenna that has a first antenna beam that points at −27 degrees in the azimuth plane and a second antenna beam that points at 27 degrees in the azimuth plane, the bends in the reflector may be +/−28 degrees, +/−30 degrees, +/−32 degrees or more (e.g., more than +/−33 degrees, +/−35 degrees or +/−40 degrees). In other words, the radiation emitted by the outside columns of radiating elements may be mechanically over-scanned to point beyond the boresight pointing directions of the respective first and second antenna beams. In this fashion, the outer columns of radiating elements generate most of the RF energy that forms the outer portions of the respective first and second antenna beams, which allows the RF energy emitted by the columns of radiating elements on the first (central) section of the reflector to be scanned less in the azimuth plane. This technique may further improve the pattern shape of the first and second antenna beams.

The reflector 240 is bent between the first and second columns 170-1 and 170-2, and between the third and fourth columns 170-3 and 170-4. Accordingly, though the fifth through eighth radiating elements 271-5 through 271-8 of the second row 160-2 (FIG. 2D) are not visible in the top view of FIG. 2E, it will be appreciated that the fifth radiating element 271-5 is on the first portion P1 of the reflector 240, the sixth and seventh radiating elements 271-6 and 271-7 are on the second portion P2 of the reflector 240, and the eighth radiating element 271-8 is on the third portion P3 of the reflector 240.

The bent portions P1 and P3 of the reflector 240 can reduce electronic scanning of radiating elements 271. For example, the second and third columns 170-2 and 170-3 (e.g., the second, third, sixth, and seventh radiating elements 271-2, 271-3, 271-6, and 271-7 thereof) may not need to be electronically scanned as far because the reflector 240 is a bent reflector having the first and second angles θ1 and θ2.

It will be appreciated that the number of radiating elements included in each column of radiating elements impacts the beamwidth of the generated antenna beams in the elevation plane, with the elevation beamwidth decreasing with increasing numbers of radiating elements in the columns. In some embodiments, the antenna array will include a single row of radiating elements (i.e., one radiating element per column). In such embodiments, the antenna will generate a pair of antenna beams (per polarization) that have large elevation beamwidths. More typically, between four and sixteen radiating elements will be included in each column so that the generated antenna beams have narrower beamwidths (e.g., half power beamwidths) in the elevation plane. The number of radiating elements provided may be selected by customer requirements for the elevation beamwidth.

It will also be appreciated that each “row” of the antenna array illustrated in FIGS. 2A and 2B may be replaced with multiple rows. For example, in another embodiment, the antenna array illustrated in FIG. 2A could have ten radiating elements per column. In such an embodiment, each “row” of the feed network 150 shown in FIG. 2B could feed two rows of radiating elements by adding additional power dividers that split the RF energy that the feed network would normally feed to a single radiating element between the two vertically stacked radiating elements. Such an approach may result in less control over the pattern shape of the antenna beams, but may reduce the complexity of the beamforming network.

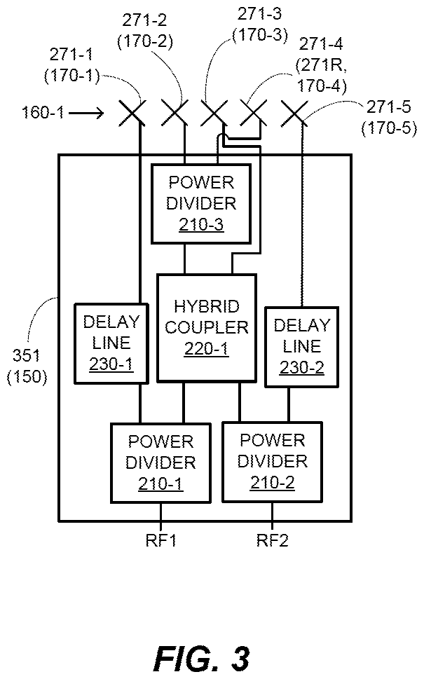

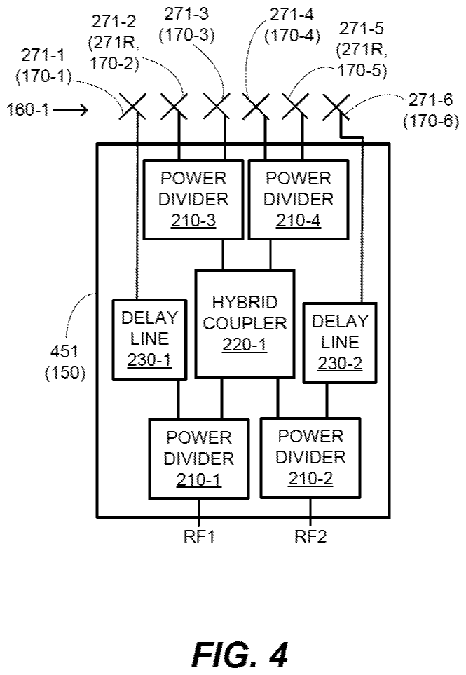

FIGS. 3 and 4 are schematic block diagrams of different examples of a portion of the feed network 150 of FIG. 1C, according to other embodiments of the present invention. As shown in FIG. 3, the first row 160-1 may include exactly five radiating elements 271 rather than exactly four radiating elements 271.

A portion 351 of the feed network 150 that is coupled to the first row 160-1 may differ from the portion 251 that is shown in FIG. 2C, in that the portion 351 includes a third power divider 210-3. The third power divider 210-3 is coupled between the first hybrid coupler 220-1 and the second and fourth radiating elements 271-2 and 271-4 (where the fourth radiating element 271-4 may be a rotated radiating element 271R). The first hybrid coupler 220-1 is also coupled to the third radiating element 271-3 (thus providing a total of three radiating elements 271 coupled to the first hybrid coupler 220-1), and the first and fifth radiating elements 271-1 and 271-5 are coupled to the first and second delay lines 230-1 and 230-2, respectively (which may be configured to provide −270 degrees and −180 degrees, respectively, of phase delay). Accordingly, the first power divider 210-1 feeds the first through fourth radiating elements 271-1 through 271-4 (and not the fifth radiating element 271-5), and the second power divider 210-2 feeds the second through fifth radiating elements 271-2 through 271-5 (and not the first radiating element 271-1). As a result, four of the five radiating elements 271 of the first row 160-1 are used simultaneously to generate each of first and second antenna beams having a narrower azimuth HPBW than when three out of four radiating elements 271 in a row 160 are used.

As shown in FIG. 4, in other embodiments, the first row 160-1 may include exactly six radiating elements 271 rather than exactly four or exactly five radiating elements 271. A portion 451 of the feed network 150 that is coupled to the first row 160-1 may differ from the portion 351 that is shown in FIG. 3, in that the portion 451 includes a fourth power divider 210-4.

The fourth power divider 210-4 is coupled between the first hybrid coupler 220-1 and the fourth and fifth radiating elements 271-4 and 271-5. The first hybrid coupler 220-1 is also coupled to the second and third radiating elements 271-2 and 271-3 via the third power divider 210-3, and the first and sixth radiating elements 271-1 and 271-6 are coupled to the first and second delay lines 230-1 and 230-2, respectively, which may each be configured to provide −180 degrees of phase delay. The first hybrid coupler 220-1 thus feeds two pairs of radiating elements 271, the outermost ones of which (i.e., the second and fifth radiating elements 271-2 and 271-5) may be rotated radiating elements 271R.

Accordingly, the first power divider 210-1 feeds the first through fifth radiating elements 271-1 through 271-5 (and not the sixth radiating element 271-6), and the second power divider 210-2 feeds the second through sixth radiating elements 271-2 through 271-6 (and not the first radiating element 271-1). As a result, five of the six radiating elements 271 of the first row 160-1 are used simultaneously to generate each of first and second antenna beams having a narrower azimuth HPBW than when four out of five radiating elements 271 in a row 160 are used.

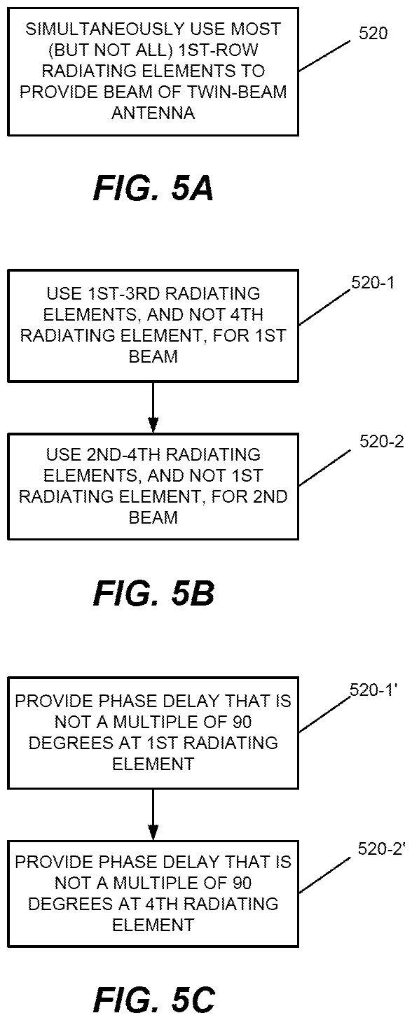

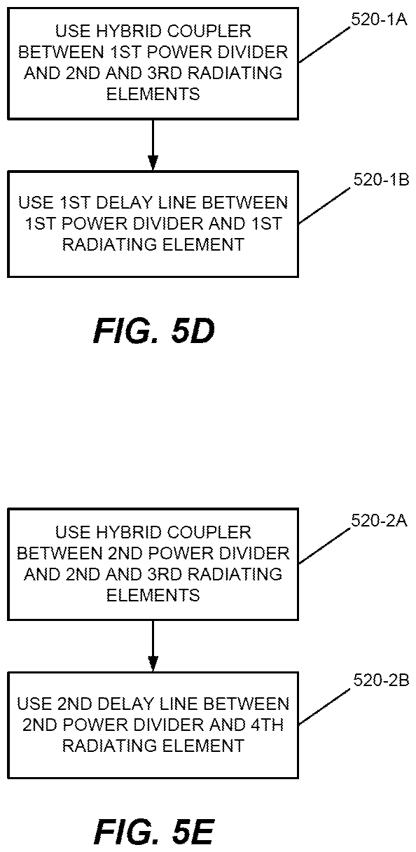

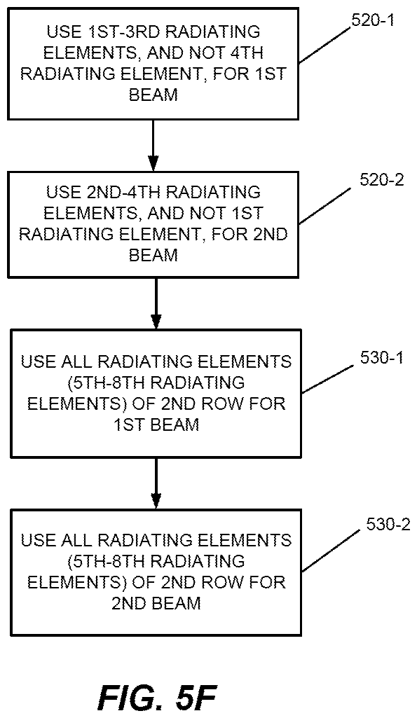

FIGS. 5A-5F are flowcharts illustrating operations of providing an antenna beam via radiating elements 271 shown in FIG. 2A. As shown in FIG. 5A, the operations include simultaneously using (Block 520) most (but not all) radiating elements 271 of the first row 160-1 (FIG. 2C) to provide an antenna beam of a twin-beam antenna 100 (FIG. 1A). For example, the antenna beam may be generated using all but one of the radiating elements 271 of the first row 160-1.

As shown in FIG. 5B, the operation(s) of Block 520 of FIG. 5A may include providing (Block 520-1) a first antenna beam via the first through third radiating elements 271-1 through 271-3 of the first row 160-1, and not via the fourth radiating element 271-4 of the first row 160-1. Moreover, the operation(s) of Block 520 of FIG. 5A may include providing (Block 520-2) a second antenna beam via the second through fourth radiating elements 271-2 through 271-4, and not via the first radiating element 271-1.

As shown in FIG. 5C, the operation(s) of Block 520-1 of FIG. 5B may include providing (Block 520-1′) a first phase delay to an RF signal that is fed to the first radiating element 271-1 that is not a multiple of ninety degrees (e.g., is not −90, −180, or −270 degrees). Moreover, the operation(s) of Block 520-2 of FIG. 5B may include providing (Block 520-2′) a second phase delay to an RF signal that is fed to the fourth radiating element 271-4 that is not a multiple of ninety degrees.

As shown in FIG. 5D, the operation(s) of Block 520-1 of FIG. 5B may be performed using (Block 520-1A) the first hybrid coupler 220-1 (FIG. 2C) between the first power divider 210-1 (FIG. 2C) and the second and third radiating elements 271-2 and 272-3, and using (Block 520-1B) the first phase-controllable delay line 230-1 (FIG. 2C) between the first power divider 210-1 and the first radiating element 271-1. Accordingly, providing the first antenna beam may include splitting, by the first power divider 210-1, the first RF signal RF1 between the first hybrid coupler 220-1 and the first phase-controllable delay line 230-1.

As shown in FIG. 5E, the operation(s) of Block 520-2 of FIG. 5B may be performed using (Block 520-2A) the first hybrid coupler 220-1 between the second power divider 210-2 (FIG. 2C) and the second and third radiating elements 271-2 and 272-3, and using (Block 520-2B) the second phase-controllable delay line 230-2 (FIG. 2C) between the second power divider 210-2 and the fourth radiating element 271-4. Providing the second antenna beam may thus include splitting, by the second power divider 210-2, the second RF signal RF2 between the first hybrid coupler 220-1 and the second phase-controllable delay line 230-2.

As shown in FIG. 5F, the first and second antenna beams may be provided using multiple rows 160 of radiating elements 271. For example, the first and second antenna beams may be provided using the first row 160-1 (by performing the operations of Blocks 520-1 and 520-2 of FIG. 5B) together with the second row 160-2 (FIG. 2A). In some embodiments, all radiating elements 271 of the second row 160-2 may be used to provide each of the first and second antenna beams. FIG. 5F thus illustrates using (Block 530-1) the fifth through eighth radiating elements 271-5 through 271-8 of the second row 160-2 for the first antenna beam, and using (Block 530-2) the fifth through eighth radiating elements 271-5 through 271-8 for the second antenna beam.

For simplicity of illustration, blocks are shown sequentially in each of FIGS. 5B-5F. According to some embodiments, however, operations of multiple blocks in FIGS. 5B-5F may be performed concurrently. As an example, operation(s) of Block 520-1 may be performed concurrently with operation(s) of Block 520-2, and/or concurrently with operation(s) of Block 530-1 and/or Block 530-2.

Twin-beam base station antennas 100 (FIGS. 1C, 1D) according to embodiments of the present invention may provide a number of advantages. These advantages include providing a wider azimuth HPBW at higher frequencies of an operating frequency band of radiating elements 271 (FIG. 2A) of an antenna 100, by using fewer than all (e.g., only three) radiating elements 271 at a time from a first row 160-1 (FIG. 2C) of radiating elements 271 to generate each of first and second antenna beams. Moreover, first and second phase-controllable delay lines 230-1 and 230-2 (FIG. 2C) may couple first and second power dividers 210-1 and 210-2 (FIG. 2C), respectively, to first and fourth radiating elements 271-1 and 271-4 (FIG. 2C), respectively, of the first row 160-1 that are not fed by the first hybrid coupler 220-1 (FIG. 2C). The first and second delay lines 230-1 and 230-2 can independently control azimuth beam peaks of the first and second antenna beams, respectively.

In some embodiments, the first hybrid coupler 220-1 may be coupled between the first and second power dividers 210-1 and 210-2 and second and third radiating elements 271-2 and 271-3 (FIG. 2C) of the first row 160-1. Accordingly, power dividers 210 may be at inputs, rather than outputs, of the first hybrid coupler 220-1. As a result, amplitude taper control of sidelobes may increase, and the risk of non-linearity of phase at the outputs of the first hybrid coupler 220-1 may be reduced.

According to some embodiments, the wider azimuth HPBW provided by the first row 160-1 may be balanced with a narrower azimuth HPBW provided by a second row 160-2 (FIG. 2D) of radiating elements. All radiating elements 271 of the second row 160-2 are fed by a second hybrid coupler 220-2 (FIG. 2D) to provide each of the first and second antenna beams. The second row 160-2 may narrow azimuth HPBW at the lower end of the operating frequency band of the radiating elements 271.

Moreover, the first and second rows 160-1 and 160-2 may share a reflector 240 (FIG. 2E) that is bent. In some embodiments, the reflector 240 may be bent by more than 27 degrees. As an example, the reflector 240 may be bent between first and second columns 170-1 and 170-2 (FIG. 2E) of radiating elements 271 and between third and fourth columns 170-3 and 170-4 (FIG. 2E) of radiating elements 271. The bent reflector 240 can reduce how much the radiating elements 271 are electronically scanned.

The present invention has been described above with reference to the accompanying drawings. The present invention is not limited to the illustrated embodiments. Rather, these embodiments are intended to fully and completely disclose the present invention to those skilled in this art. In the drawings, like numbers refer to like elements throughout. Thicknesses and dimensions of some components may be exaggerated for clarity.

Spatially relative terms, such as “under,” “below,” “lower,” “over,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Herein, the terms “attached,” “connected,” “interconnected,” “contacting,” “mounted,” “coupled,” and the like can mean either direct or indirect attachment or coupling between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

1. A twin-beam base station antenna comprising:
an antenna array comprising a plurality of radiating elements;
first and second power dividers; and
a hybrid coupler that is coupled between the first and second power dividers and a pair of the radiating elements that are in a row of the antenna array.

2. The twin-beam base station antenna of claim 1, wherein the hybrid coupler is not coupled to any radiating element other than the pair of the radiating elements.

3. The twin-beam base station antenna of claim 1, wherein the pair of the radiating elements comprises consecutive radiating elements in the row.

4. The twin-beam base station antenna of claim 1, wherein no power divider is coupled between the hybrid coupler and any radiating element of the pair of the radiating elements.

5. The twin-beam base station antenna of claim 1, further comprising first and second phase-controllable delay lines that bypass the hybrid coupler,
wherein the row comprises first through fourth radiating elements,
wherein the first power divider is coupled to the first radiating element by the first phase-controllable delay line,
wherein the pair of the radiating elements comprises the second and third radiating elements, and
wherein the second power divider is coupled to the fourth radiating element by the second phase-controllable delay line.

6. The twin-beam base station antenna of claim 5,
wherein the first through fourth radiating elements are consecutive radiating elements in the row,
wherein the row comprises a first row of the antenna array, and
wherein a second row of the antenna array comprises consecutive fifth through eighth radiating elements.

7. The twin-beam base station antenna of claim 6, wherein the second radiating element is rotated 180 degrees relative to the first, third, and fourth radiating elements.

8. The twin-beam base station antenna of claim 6, further comprising a reflector,
wherein the first and fifth radiating elements are on a first portion of the reflector,
wherein the second, third, sixth, and seventh radiating elements are on a second portion of the reflector,
wherein the fourth and eighth radiating elements are on a third portion of the reflector, and
wherein the first and third portions of the reflector are bent relative to the second portion of the reflector.

9. (canceled)

10. The twin-beam base station antenna of claim 6,
wherein the hybrid coupler comprises a first hybrid coupler, and
wherein the twin-beam base station antenna further comprises:
a second hybrid coupler; and
third and fourth power dividers that are coupled between the second hybrid coupler and the second row.

11. (canceled)

12. The twin-beam base station antenna of claim 1,
wherein a total of three of radiating elements in the row are coupled to the hybrid coupler, or
wherein the pair of the radiating elements comprises a first pair of radiating elements in the row, and the hybrid coupler is also coupled to a second pair of radiating elements in the row.

13. A twin-beam base station antenna comprising:
first and second radiating elements;
a power divider;
a hybrid coupler that is coupled between the power divider and the second radiating element; and
a phase-controllable delay line that bypasses the hybrid coupler and is coupled between the power divider and the first radiating element.

14. The twin-beam base station antenna of claim 13, wherein only two radiating elements are coupled to the hybrid coupler.

15. The twin-beam base station antenna of claim 13, further comprising a third radiating element,
wherein the third radiating element is coupled to the hybrid coupler, and
wherein the second radiating element is rotated 180 degrees relative to the first and third radiating elements.

16. The twin-beam base station antenna of claim 13,
wherein the power divider comprises a first power divider that is configured to split a first radio frequency (RF) signal between the hybrid coupler and the phase-controllable delay line,
wherein the phase-controllable delay line comprises a first phase-controllable delay line,
wherein the twin-beam base station antenna further comprises:
a third radiating element that is coupled to the hybrid coupler;
a fourth radiating element;
a second power divider; and
a second phase-controllable delay line that bypasses the hybrid coupler and is coupled between the second power divider and the fourth radiating element, and
wherein the second power divider is configured to split a second RF signal between the hybrid coupler and the second phase-controllable delay line.

17. The twin-beam base station antenna of claim 16, wherein the second phase-controllable delay line is configured to provide a different phase delay from the first phase-controllable delay line.

18. The twin-beam base station antenna of claim 16,
wherein the second radiating element is between the first radiating element and the third radiating element, and
wherein the third radiating element is between the second radiating element and the fourth radiating element.

19. A twin-beam base station antenna comprising:
first through fourth radiating elements; and
a reflector comprising a first portion having the first radiating element thereon, a second portion having the second and third radiating elements thereon, and a third portion having the fourth radiating element thereon,
wherein the first portion of the reflector is bent more than 33 degrees relative to the second portion of the reflector, and
wherein the third portion of the reflector is bent more than 33 degrees relative to the second portion of the reflector.

20. The twin-beam base station antenna of claim 19, wherein the first portion of the reflector is bent more than 35 degrees relative to the second portion of the reflector.

21. The twin-beam base station antenna of claim 19, wherein the third portion of the reflector is bent more than 35 degrees relative to the second portion of the reflector.

22. The twin-beam base station antenna of claim 19, further comprising:
a power divider;
a hybrid coupler that is coupled between the power divider and the second and third radiating elements; and
a phase-controllable delay line that bypasses the hybrid coupler and is coupled between the power divider and the first radiating element,
wherein the first through fourth radiating elements are in a row of an antenna array.

23-27. (canceled)
